(19) United States
(12) Patent Application Publication
(10) Pub. No.: US 2016/0288620 A1
(43) Pub. Date: Oct. 6, 2016

(54) ELECTRIC THERMAL FLUID CONDITIONING DEVICE FOR A MOTOR VEHICLE AND CORRESPONDING HEATING AND/OR AIR-CONDITIONING FACILITY

(71) Applicant: VALEO SYSTEMES THERMIQUES, Le Mesnil Saint-Denis (FR)

(72) Inventors: Frédéric Pierron, Rambouillet (FR); José Leborgne, Elancourt (FR); Laurent Tellier, Paris (FR)

(73) Assignee: Valeo Systemes Thermiques, Le Mesnil Saint Denis (FR)

(21) Appl. No.: 15/034,556

(22) PCT Filed: Oct. 16, 2014
(86) PCT No.: PCT/EP2014/072272

§ 371 Date: May 5, 2016

(30) Foreign Application Priority Data
Nov. 7, 2013 (FR) 1360927

(51) Int. Cl. B60H 1/22; F24H 1/10; F24H 9/00; F24H 9/18

(52) U.S. Cl. CPC B60H 1/2215; F24H 9/1818; F24H 1/102; F24H 9/0021

(57) ABSTRACT

The invention relates to an electric thermal fluid conditioning device (1) for a motor vehicle, said device (1) comprising at least two thermal modules (3a, 3b) arranged for a parallel flow of the fluid in a direction shared to both thermal modules (3a, 3b), a thermal module (3a, 3b) comprising,—an enclosure (13a, 13b), and—a core (11a, 11b) arranged inside the enclosure (13a, 13b), so as to include a guide circuit (15a, 15b) for the fluid between the core (11a, 11b) and the enclosure (13a, 13b). According to the invention, the core (11a, 11b) of a thermal module (3a, 3b) comprises at least one electric means (17) for heating the fluid, so as to allow a heat transfer between the electric heating means (17) and the fluid able to flow in the guide circuit (15a, 15b).

The invention relates to an electric device for thermally conditioning a fluid for a motor vehicle. In particular it consists of an electric heating device. The invention is applicable more particularly to heating and/or air-conditioning systems of motor vehicles.

Usually, the reheating of the air intended to heat the passenger compartment of a motor vehicle or also to perform demisting or de-icing is achieved by means of an air flow passing through a heat exchanger, more precisely by a heat exchange between the air flow and a fluid. Said fluid generally consists of the cooling fluid in the case of a heat engine.

However, this heating method may prove to be unsuitable or insufficient to ensure rapid and efficient heating of the passenger compartment of the vehicle, in particular reheating of the compartment or de-icing or demisting before using the vehicle in very cold conditions or when a very rapid increase in the temperature is required.

Moreover, in the case of an electric vehicle, the heating function is no longer performed by means of circulation of the cooling fluid in the heat exchanger. It is possible to envisage a water circuit for heating the passenger compartment. However, this heating method may also prove to be unsuitable or insufficient for ensuring rapid and efficient heating of the vehicle passenger compartment.

Moreover, in order to reduce the volume and the cost of an additional water circuitry, it is also known to use for the electric vehicle an air-conditioning loop operating as a heat pump. Thus, the air-conditioning loop, by allowing conventionally an air flow to be cooled by means of a cooling fluid, is in this case used to reheat the air flow. For this purpose it is convenient to use an evaporator of the air-conditioning loop, such as a condenser.

However, this heating method may also prove to be unsuitable or insufficient. In fact, the performance of the air-conditioning loop when acting as a heat pump depends on the external temperature conditions. For example, when the external air has a very low temperature this air cannot be used as a source of heat energy.

In order to overcome these drawbacks of the prior art, a known solution consists in adding to the heat exchanger or to the water circuit or also to the air-conditioning loop an additional electric device for thermally conditioning the fluid, such as an electric heating device.

Such an electric heating device may be adapted to heat the fluid upstream, such as the cooling liquid for the heat engine, or the water for the water circuit for heating the passenger compartment of the electric vehicle or also the cooling fluid of the air-conditioning loop.

In a known manner, the additional electric device for thermally conditioning the fluid comprises one or more thermal modules in contact with the fluid to be heated for example.

More precisely, a thermal module may comprise a core and a heating element in the form of a cylindrical enclosure surrounding the core, in order to define a guide circuit for the fluid between the core and the cylindrical enclosure. The cylindrical enclosure is therefore the source of thermal energy.

According to a known solution, a heating element has electric heating means, for example one or more heating resistances produced by means of silk-screen printing in the form of resistive tracks on the external surface of the heating element.

However, an axial flow of the fluid in the guide circuit between the core and the cylindrical enclosure reduces the heat transfer between the cylindrical enclosure and the fluid.

In order to increase the efficiency of the heat exchange between the heating element and the fluid flowing between the core and the heating element, it is therefore preferable to avoid a flow of the fluid parallel to the axis of the heating element in the form of a cylindrical enclosure.

A known solution is to generate a helical movement of the fluid flowing in the guide circuit. The heat exchange between the heating element for example in the form of a cylindrical enclosure and the fluid flowing inside this cylindrical enclosure is thus increased.

In order to achieve this, it has been proposed to provide the core with a substantially helical groove on its external surface. This helical groove is able to cause swirling of the fluid so as to increase the heat transfer. However, with such a solution a lack of uniformity of speeds at the inlet of the fluid guide circuit and a high head loss have been noted. Moreover, such a core therefore has a complex design.

Moreover, in the case of an electric heating device comprising several thermal modules, for example two thermal modules arranged side by side, in order to improve the thermal efficiency of the electric heating device, it is important to have a balanced fluid flowrate and fluid temperature between the thermal modules of the device.

The invention aims to overcome at least partially these drawbacks of the prior art by proposing a thermal conditioning device for fluid which is able to improve the thermal performance in a simple manner.

To achieve this aim, the invention relates to an electric device for thermally conditioning a fluid for a motor vehicle, the said device comprising at least two thermal modules arranged so as to obtain a parallel flow of the fluid in a common direction inside the two thermal modules, a thermal module comprising:
an enclosure, and
a core arranged inside the enclosure, so as to define a guide circuit for the fluid between the core and the enclosure,

characterized in that the core of a thermal module comprises at least one electric means for heating the fluid, so as to allow heat transfer between the electric heating means and the fluid able to flow in the guide circuit.

Thus, heating of the fluid performed with such a thermal conditioning device by means of immersion of the electric heating means in the guide circuit for the fluid to be heated is able to improve the heat transfer and therefore obtain a better performance than the known solutions in which the electric heating means is arranged on the enclosures on the outside of the fluid guide circuit.

Moreover, the arrangement of the thermal modules so as to obtain a fluid flow in the two thermal modules which is independent and in a common direction is able to improve the reliability of the device, in particular in the event of a malfunction of one of the thermal modules.

Moreover, the fluid flowrate is uniform in the two thermal modules.

According to one aspect of the invention, the core comprises a support for the electric heating means made of an electrically insulating and heat-conducting material, such as a ceramic material.

According to an example of embodiment, the electric heating means comprises at least one resistive track and the core comprises a protective film arranged on the resistive track and made of an electrically insulating and heat-conducting material, such as a ceramic material.

The protective film is for example made of the same material as the support for the electric heating means.

The core thus allows the installation of the electric heating means within the circuit of the fluid to be heated while ensuring the electrical insulation in relation to the fluid without altering the thermal performance, since it helps increase the heat conductivity of the electric heating means in relation to the fluid to be heated.

According to another aspect of the invention, the cores have respectively two terminals able to be connected to a means for controlling the associated electric heating means and overmolded on the material of the core of the corresponding support. It is not required to provide an interface or an additional cable for connection of the electric heating means mounted on the core to the control means.

In fact, the cores may be connected directly to the control means of the electric heating means via the terminals overmolded on the materials of the respective supports and allowing the current to be transferred to the electric heating means.

The device may also comprise one or more of the following characteristic features, considered singly or in combination:
the electric means for heating the cores of the two thermal modules are connected electrically to a common control means;
the control means is arranged opposite one end of at least one core;
the enclosures are made in the form of a single block having at least two seats for receiving a corresponding core.

According to another aspect of the invention, the said device comprises at least one fluid inlet pipe and at least one fluid outlet pipe communicating respectively with the fluid guide circuits and arranged opposite each other on either side of the device along a longitudinal axis. This opposite arrangement of the fluid inlet and outlet on either side of the device, along a longitudinal axis of the cores, facilitates installation in the motor vehicle.

Furthermore, this arrangement allows a fluid flow in a common direction in the guide circuits of the two thermal modules. When this direction is from the bottom upwards, in relation to installation of the device in a motor vehicle, the risks of air bubbles being formed inside the fluid guide circuits and being able to alter the performance of the thermal modules is thus reduced.

The invention also relates to a heating and/or air-conditioning facility for a motor vehicle, characterized in that it comprises an electric device for thermally conditioning a fluid as defined above.

Further characteristic features and advantages of the invention will appear more clearly from a reading of the following description provided by way of a non-limiting example and from the attached drawings in which:

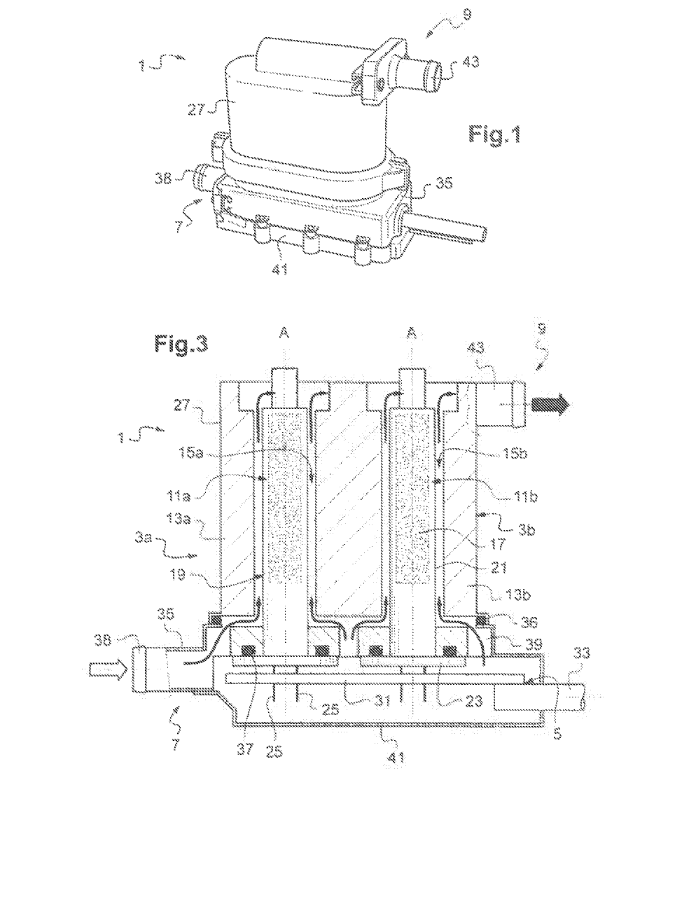

FIG. 1 shows in a schematic and simplified form an electric fluid heating device for a motor vehicle;

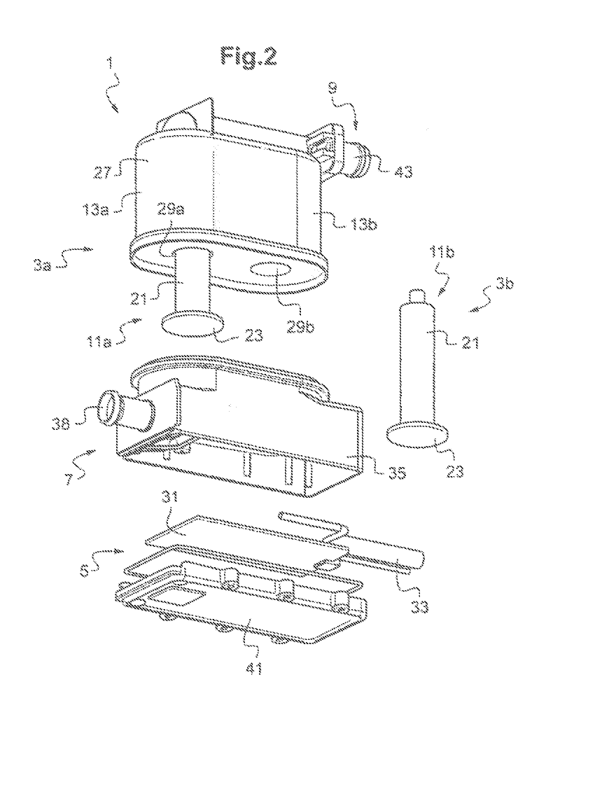

FIG. 2 is an exploded view of the heating device shown in FIG. 1; and

FIG. 3 is a cross-sectional view of the heating device shown in FIGS. 1 and 2.

In these figures, identical elements have the same reference numbers.

FIG. 1 shows a device 1 for thermally conditioning a fluid, such as an electric heating device for the fluid for a heating and/or air-conditioning facility of a motor vehicle.

The thermal conditioning device 1 is, for example, an additional heating device allowing heating of a fluid arranged in a fluid heating circuit of the vehicle for heating the passenger compartment.

According to an example, the thermal conditioning device 1 is arranged upstream of a heat exchanger of an air-conditioning loop able to function as a heat pump, so as to heat the cooling fluid.

According to another example, the thermal conditioning device 1 is arranged upstream of the heat exchanger using the cooling fluid of a heat engine as heat transfer fluid.

Such a thermal conditioning device 1 could also be provided upstream of a heat exchanger intended for the thermal regulation of an electric energy storage device, sometimes referred to as a battery pack or fuel cell, for an electrically propelled or hybrid vehicle.

With reference to FIG. 2 and FIG. 3, the thermal conditioning device 1 is now described in greater detail.

The thermal conditioning device 1 comprises at least one first thermal module 3a and a second thermal module 3b. Of course the thermal conditioning device 1 may comprise more than two thermal modules 3a, 3b, depending on requirements.

In order to control the electric power supply of the thermal modules 3a, 3b, the thermal conditioning device 1 also comprises at least one control means 5. According to the embodiment described, the thermal conditioning device 1 comprises a common control means 5 for controlling the electric power supply of the two thermal modules 3a, 3b.

The thermal conditioning device 1 shown further comprises a fluid inlet 7 and a fluid outlet 9.

The thermal modules 3a, 3b may be identical.

The two thermal modules 3a, 3b according to the embodiment shown in FIGS. 2 and 3 are arranged side by side in a substantially parallel manner. Owing to the side-by-side arrangement, the volume of the heating device 1 in the longitudinal direction may be reduced. This arrangement results in a limited thermal conditioning inertia and a small head loss.

Furthermore, the two thermal modules 3a, 3b are arranged so as to achieve a fluid flow in the two thermal modules 3a, 3b which is parallel and in a common direction. By way of example, the fluid is able to flow in the two thermal modules 3a, 3b from the bottom upwards according to the layout shown in FIGS. 1 to 3.

This arrangement is of particular interest because the two thermal modules 3a and 3b are independent in terms of fluid flow. Thus, for example, in the event of a malfunction of one of the thermal modules 3a or 3b, this does not affect the performance of the other thermal module. Thus, differently from the solutions of the prior art in which the fluid flows firstly inside one thermal module and then inside the other thermal module, the malfunction of the first thermal module does not result in the loss of performance of the second thermal module.

Moreover, when the fluid flows in a direction from the bottom upwards as schematically shown in FIG. 3, this helps prevent the formation in the thermal module(s) of air bubbles which would risk causing overheating of the thermal module(s) concerned.

With reference to FIG. 3, the thermal modules 3a, 3b comprise, respectively, a core 11a, 11b and an enclosure 13a, 13b surrounding the associated core 11a or 11b. A core 11a, 11b is therefore arranged inside an associated enclosure 13a, 13b, The cores 11a, 11b are respectively central cores 11a, 11b.

The central cores 11a, 11b and associated enclosures 13a, 13b define, respectively, a guide circuit 15a, 15b for the fluid, to be heated for example, between the central core 11a or 11b and the associated enclosure 13a or 13b. Thus, the external surface of a central core 11a or 11b and the internal surface of the associated enclosure 13a and 13b define a flow volume for the fluid, in the example the fluid to be heated.

The cores 11a and 11b are for example substantially cylindrical and extend along a longitudinal axis A.

The core 11a, 11b may have a substantially constant or, alternatively, tapered cross section. In the case of a substantially constant cross section of the central core 11a, 11b, the fluid may flow with a constant speed in the associated guide circuit 15a, 15b. On the other hand, in the case of a tapered cross section, the flow speed is modified along the guide circuit 15a, 15b.

The cores 11a or 11b of the thermal modules 3a, 3b have according to the example described respectively two longitudinally opposite ends: a first end arranged on the fluid inlet side and a second opposite end arranged on the fluid outlet side.

According to the invention, the cores 11a, 11b comprise, respectively, an electric heating means 17. The electric heating means 17 is able to be controlled by the control means 5 so as to heat the fluid flowing in the guide circuit 15a or 15b by means of heat exchange between the core 11a, 11b and the fluid inside which the core 11a, 11b is immersed.

The guide circuit 15a, 15b is therefore defined around the one or more electric means 17 for heating the core 11a or 11b. Thus, heating is performed by means of immersion of the electric heating means 17 in the fluid to be heated, flowing in the guide circuit 15a or 15b. Owing to this embodiment, the heat produced by the electric heating means 17 is directly transmitted to fluid to be heated, thereby minimizing the heat losses and reducing the thermal inertia of the device 1. The fluid may be rapidly heated.

furthermore, the external surface of the core 11a or 11b may be without a groove, so as to define an axial guide circuit parallel to the longitudinal axis A.

In fact, it is no longer necessary to provide a—for example helical—flow of the fluid in order to improve the heat transfer because the immersion of the electric heating means 17 in the volume of fluid to be heated already ensures an improvement of the heat transfer.

Moreover, the cores 11a, 11b each have for example a support 19 for the electric heating means 17.

The support 19 therefore has the function of allowing the arrangement of the electric heating means 17 in the thermal conditioning device 1, for example for performing heating as described.

The support 19 is made of an electrical insulating, but heat-conducting material.

The support 19 may have a body 21 and a base or seat 23 at one end of the body 21, more precisely in the region of the first end of the core 11a, 11b.

The base 23 is in the example shown arranged on the side where the fluid inlet 7 is situated.

The body 21 may have a substantially cylindrical shape and the base 23 for example a substantially circular shape. The body 21 is for example a solid body, such as a solid cylinder.

The electric heating means 17 may for example have at least one electric resistive track formed on the support 19, more precisely on the body 21 of the support 19.

Moreover, according to the embodiment described, the cores 11a, 11b in each case have a protective film (not visible in the drawings) arranged on the electric resistive track. Said film consists for example of a flexible film wound around the support 19 so as to protect the resistive track(s). This protective film is made of a heat-conducting and electrically insulating material. Advantageously, said material is the same material as that of the support 19, for example a ceramic material.

The support 19 and the protective trim have the additional function of assisting the heat transfer between the electric heating means 17 and the fluid around the core 11a, 11b.

The assembly forming the core 11a or 11b, i.e. the support 19 and the protective film arranged on the resistive tracts, may be fixed together by means of treatment in an oven.

The core 11a or 11b comprises moreover two terminals 25 for connecting the electrical heating means 17 to electric potentials, via the control means 5. The terminals 25 are therefore able to transfer the electric current to the electric heating means 17.

The terminals 25 may be designed in the form of flexible tongues able to be clipped for example onto the control means 5 or also connection wires able to be soldered for example on the control means 5.

In the example shown in FIG. 3, the terminals 25 project from the base 23 of the support 19.

The terminals 25 are for example overmolded on the—for example ceramic—material of the support 19 and may be connected directly to the control means 5. This simplifies the wiring. The support 19 thus performs the function of interconnecting the electric means 17 and the control means 5 via the terminals 25.

Thus, the core 11a, 11b performs simultaneously the mechanical function of supporting the electric heating means 17 and supporting and protecting the terminals, ensuring the connection between the electric heating means 17 and the control means 5, and the function of electrically insulating the electric heating means 17 in relation to the fluid guide circuit 15a, 15b, and also that of ensuring the thermal conductivity of the heat of the electric heating means 17 in relation to the fluid.

Moreover, as regards the enclosures 13a and 13b respectively housing the cores 11a and 11b, the enclosure 13a of the first thermal module 3a may be made as one piece with the enclosure 13b of the second thermal module 3b.

As can be more clearly seen in FIG. 2, the two enclosures 13a, 13b thus form a single block 27 having two seats 2 9a and 29b for respectively receiving the associated core 11a or 11b.

As regards the control means 5, it is arranged opposite the terminals 25 of the cores 11a and 11b of the thermal modules 3a and 3b.

According to the example shown, the control means 5 is therefore arranged opposite the bases 23 which are respectively arranged at a longitudinal end of the support 19 carrying the electric heating means 17. In this case, the control means 5 is therefore placed opposite the first ends of the cores 11a, 11b.

Of course, it is possible to envisage a different arrangement of the control means 5, for example on one side of the thermal conditioning device 1.

The control means 5 may comprise at least one electric circuit board such as a PCS Sprinted circuit board) 31. The terminals 25 of the cores 11a and 11b of the two thermal modules 3a and 3b are, according to the example shown in FIG. 3, connected to a common control means 5 and more particularly to the same electric circuit board 31.

The control means 5 comprises in particular electronic and/or electrical components mounted on the electric circuit board 31. These electronic and/or electrical components may comprise for example a micro-controller and electrical contacts connected to the resistive tracks of the cores 11a and 11b. The electric circuit board 31 may also comprise at least one power supply and signal connector 33.

As mentioned above, the thermal conditioning device 1 also comprises at least one fluid inlet 7 for entry of the fluid, schematically indicated by the white arrow in FIG. 3, and at least one fluid outlet 9 for discharging the fluid, schematically indicated by the black arrow in FIG. 3.

According to the example shown, the fluid inlet 7 comprises a fluid inlet housing 35.

The fluid inlet housing 35 is fixed to the enclosures 13a, 13b, more precisely in this example to the single block 27 containing the two cores 11a and 11b. One or more sealing means 36 may be arranged between the fluid inlet housing 35 and the enclosures 13a and 13b (cf. FIG. 3).

Furthermore, the respective bases 23 of the cores 11a and 11bof the two thermal modules 3a and 3b are in this example fixed to the fluid inlet housing 35. One or more sealing means 37 may be arranged between the bases 23 of the supports 19 of the cores 11a, 11b and the fluid inlet housing 35.

The fluid inlet housing 35 is also provided with a fluid inlet pipe 38. The inlet pipe 38 may supply in common the two thermal modules 3a, 3b with fluid. The inlet pipe 38 is for example arranged projecting from the fluid inlet housing 35. The inlet pipe 38 extends for example radially in relation to the longitudinal axis A of the thermal modules 3a, 3b.

In the example shown, the fluid inlet housing 35 has a fluid inlet duct 39 in fluid communication with the inlet pipe 38 and with the guide circuits 15a and 15b of the two thermal modules 3a and 3b. This allows the fluid to flow from the inlet pipe 38 into the guide circuits 15a and 15b, as schematically shown by the arrows in FIG. 3.

The thermal conditioning device 1 comprises moreover a cover 41 fixed to the fluid inlet housing 35. The control means 5 is for example arranged between the fluid inlet housing 35 and the cover 41. The cover 41 acts as a protective cover for the control means 5. This cover 41 has for example an opening for allowing insertion of the power supply and signal connector 33.

Similarly, an outlet pipe 43 in fluid communication with the guide circuits 15a and 15b of the thermal modules 3a, 3b may be provided for discharging the fluid. Thus, the fluid from the fluid inlet housing 35 may flow into the fluid inlet duct 39 and then into the guide circuits 15a, 15b of the two thermal modules 3a and 3b, before being discharged via the outlet pipe 43.

In the example shown, the outlet pipe 43 is arranged so as to be substantially perpendicular to the longitudinal axis A of the thermal module 3a, 3b.

Moreover, the inlet pipe 38 and the outlet pipe 43 may be arranged on two opposite sides of the device 1. Of course, other arrangements are possible, with for example the inlet pipe 38 and outlet pipe 43 being provided on a same side of the device 1.

A thermal conditioning device 1 thus designed is able to limit the head loss and has a smaller volume compared to certain solutions of the prior art, while it increases the beat transfer. In fact, the heat produced by the electric heating means 17, for example realized in the form of resistive tracks, is directly transmitted to the fluid in which the core 11a or 11b is immersed.

Furthermore, the parallel flow of the fluid in a common direction, for example from the bottom upwards during installation in the motor vehicle, is able to ensure a uniform flowrate in the two thermal modules 3a and 3b and avoid in particular the formation of air bubbles in the guide circuits 15a and 15b of the two thermal modules 3a and 3b.

1. An electric device for thermally conditioning a fluid for a motor vehicle, the device comprising:
at least two thermal modules arranged so as to obtain a parallel flow of the fluid in a common direction inside the two thermal modules, each thermal module comprising:
an enclosure, and
a core arranged inside the enclosure, so as to define a guide circuit for the fluid between the core and the enclosure,
wherein the core of each of the at least two thermal modules comprises at least one electric means for hearing the fluid, so as to allow heat transfer between the electric heating means and the fluid able to flow in the guide circuit.

2. The device as claimed in claim 1, wherein the core comprises a support for the electric heating means made of an electrically insulating and heat-conducting material comprising a ceramic material.

3. The device as claimed in claim 2, wherein the electric heating means comprises at least one resistive trade, and wherein the core comprises a protective film arranged on the resistive track and made of an electrically insulating and heat-conducting material, such as a ceramic material.

4. The device as claimed in claim 3, wherein the protective film is made of the same material as the support for the electric heating means.

5. The device as claimed in claim 2, wherein the cores have respectively two terminals able to he connected to a means for controlling the associated electric heating means and overmolded on the material of the support of the corresponding core.

6. The device as claimed in claim 1, wherein the electric means for heating the cores of the two thermal modules are connected electrically to a common control means.

7. The device as claimed in claim 6, wherein the common control means is arranged opposite one end of at least one core.

8. The device as claimed in claim 1, wherein the enclosures are made in the form of a single block having at least two seats for receiving a corresponding core.

9. The device as claimed in claim 1, comprising at least one fluid inlet pipe and at least one fluid outlet pipe communicating respectively with the fluid guide circuits and arranged opposite each other on either side of the device along a longitudinal axis.

10. A heating and/or air-conditioning facility for a motor vehicle, comprising at least one device for thermally conditioning a fluid as claimed in claim 1.
